(19) United States
(12) Patent Application Publication
(10) Pub. No.: US 2020/0353757 A1
(43) Pub. Date: Nov. 12, 2020

(54) IMAGE FORMING APPARATUS

(71) Applicant: ALPS ALPINE CO., LTD., Tokyo (JP)

(72) Inventors: Kazuhiro HONDA, Miyagi (JP); Teru NISHIYAMA, Miyagi (JP); Minoru TAKEUCHI, Miyagi (JP); Masahiko KITAMURA, Tokyo (JP); Takumi TOHATA, Tokyo (JP); Akira YANAGIDA, Miyagi (JP); Yoshibumi ABE, Miyagi (JP); Munenari CHIBA, Miyagi (JP); Takehiro KOBA, Miyagi (JP)

(21) Appl. No.: 16/864,531

(22) Filed: May 1, 2020

(30) Foreign Application Priority Data
May 7, 2019 (JP) 2019-087886

(51) Int. Cl. B41J 2/32; B41J 11/04; B41J 15/04; B41J 25/312

(52) U.S. Cl. CPC B41J 2/32; B41J 25/312; B41J 15/042; B41J 11/04

(57) ABSTRACT

An image forming apparatus includes a frame, a platen roller having a first end and a second end, each of the first and second ends being rotatably supported by the frame, a thermal head that faces the platen roller and that forms an image on a printing medium, the thermal head having a first end and a second end, a gear that is provided on the first end of the platen roller and that is rotated by a motor, the rotation of the gear causing the platen roller to rotate, and a pair of urging units that urges the first end and the second end of the platen roller or the thermal head, wherein an urging force generated by one of the pair of urging units on the first end is smaller than an urging force generated by the other of the pair of urging units on the second end.

### CROSS-REFERENCE TO RELATED APPLICATION

This patent application is based on and claims priority to Japanese Patent Application No. 2019-087886 filed on May 7, 2019, the entire contents of which are incorporated herein by reference.

### BACKGROUND OF THE INVENTION

### 1. Field of the Invention

The present disclosure relates to an image forming apparatus.

### 2. Description of the Related Art

Thermal printers have employed a configuration in which an image is formed on a print medium by heating the print medium with heating elements provided in a thermal head while the print medium (e.g., thermal paper) is interposed between the thermal head and a platen roller, so that the print medium is pressed against the thermal head.

In the thermal printer with such a configuration, a technique that provides a pair of right and left springs provided on both ends of the thermal head or the platen roller and urges both ends of the thermal head or the platen roller toward a print medium with the pair of springs, is used (for example, see Patent Document 1).

### RELATED-ART DOCUMENTS

### [Patent Document]

Patent Document 1: Japanese Laid-Open Patent Publication No. 03-99865

### SUMMARY OF THE INVENTION

According to one aspect of an embodiment, an image forming apparatus includes a frame, a platen roller having a first end and a second end, each of the first and second ends being rotatably supported by the frame, a thermal head that faces the platen roller and that forms an image on a printing medium interposed between the platen roller and the thermal head, the thermal head having a first end and a second end, a gear that is provided on the first end of the platen roller and that is rotated by receiving a driving force from a motor, the rotation of the gear causing the platen roller to rotate, and a pair of urging means configured to urge the first end and the second end of the platen roller or the thermal head, wherein an urging force generated by one of the pair of urging means provided on the first end is smaller than an urging force generated by the other of the pair of urging means provided on the second end.

### BRIEF DESCRIPTION OF THE DRAWINGS

FIG. 1 is a perspective view illustrating an appearance of a thermal printer according to an embodiment;

FIG. 2 is a right side view of a thermal printer according to the embodiment;

FIG. 3 is a front view of a thermal printer according to the embodiment;

FIG. 4 is a cross-sectional view of the thermal printer illustrated in FIG. 1 taken along the line A-A;

FIG. 5 is a drawing for describing an operation of a thermal printer according to the embodiment; and

FIG. 6 is a drawing illustrating one example of a thermal printer according to the embodiment.

### DESCRIPTION OF THE PREFERRED EMBODIMENTS

The inventors of this application have recognized that a difference between a right press force and a left press force of the platen roller toward the print medium is caused in printing when a spring force of a pair of springs is equal to each other, and as a result, there is a possibility that a difference between right printing density and left printing density on the print medium is caused.

In the following, an embodiment will be described with reference to the drawings.

(Basic Configuration of a Thermal Printer 100)

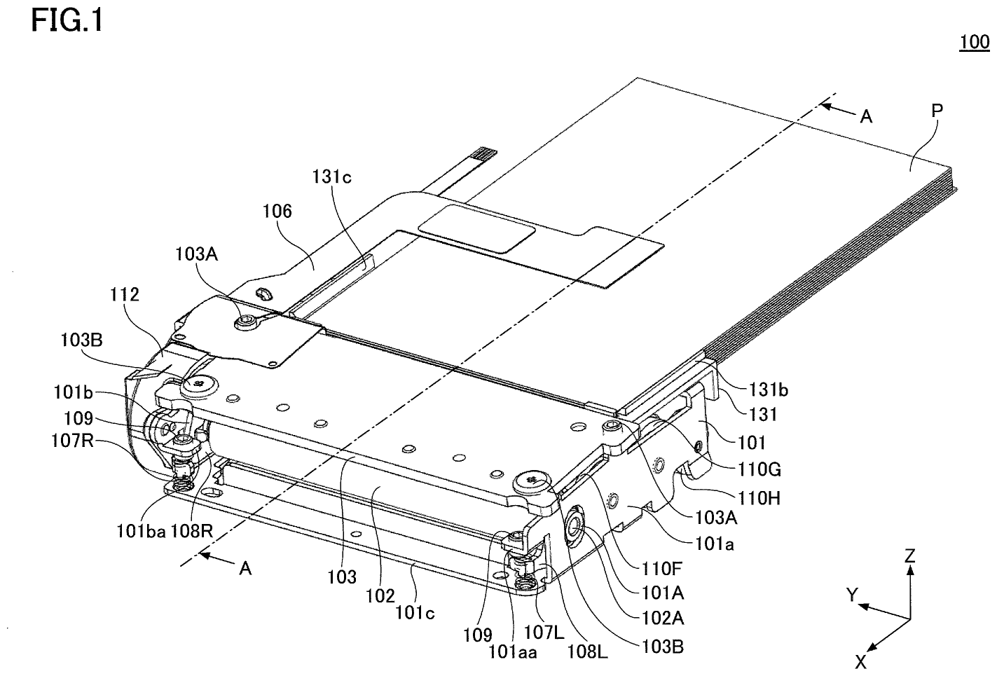

First, with reference to FIGS. 1 to 4, a basic configuration of a thermal printer 100 according to the embodiment will be described.

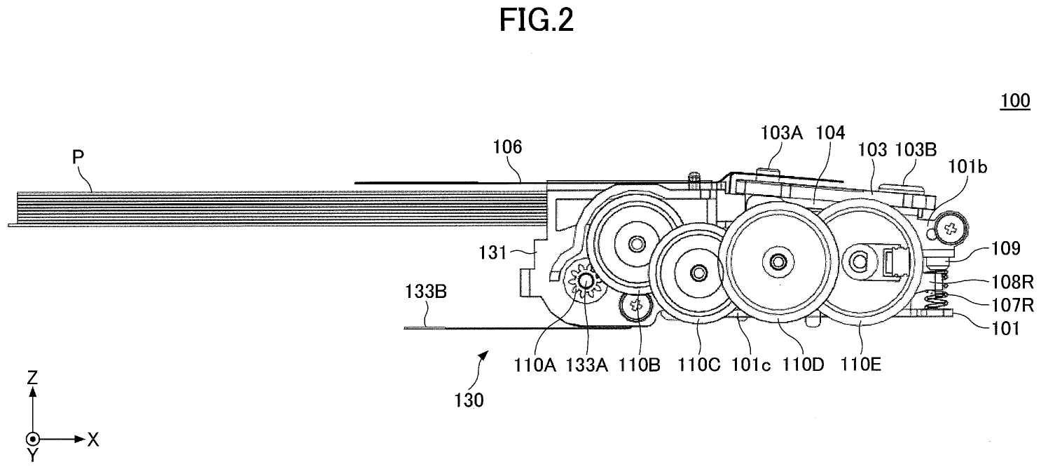

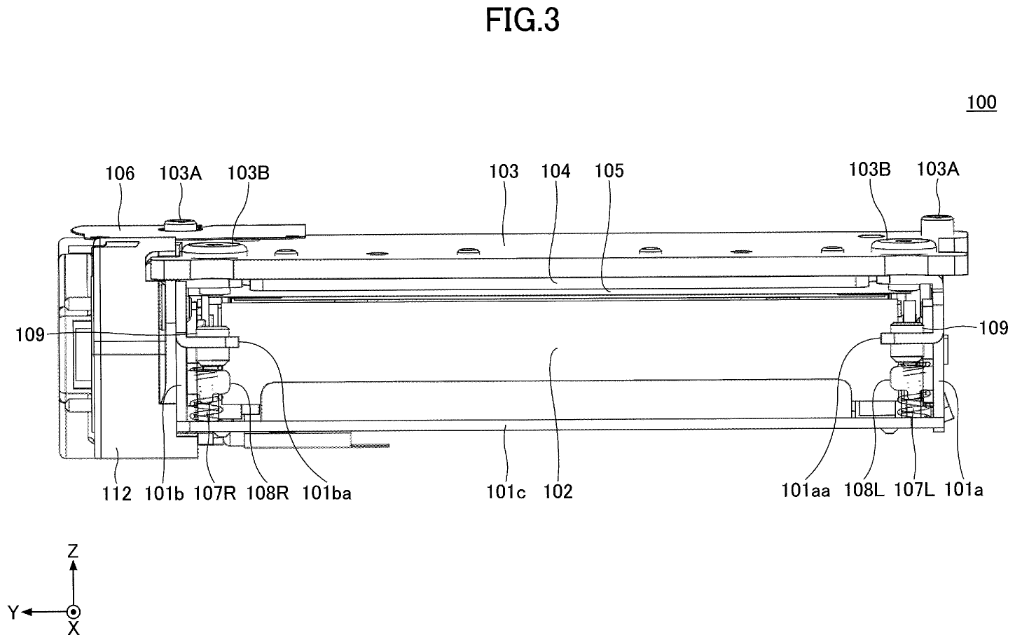

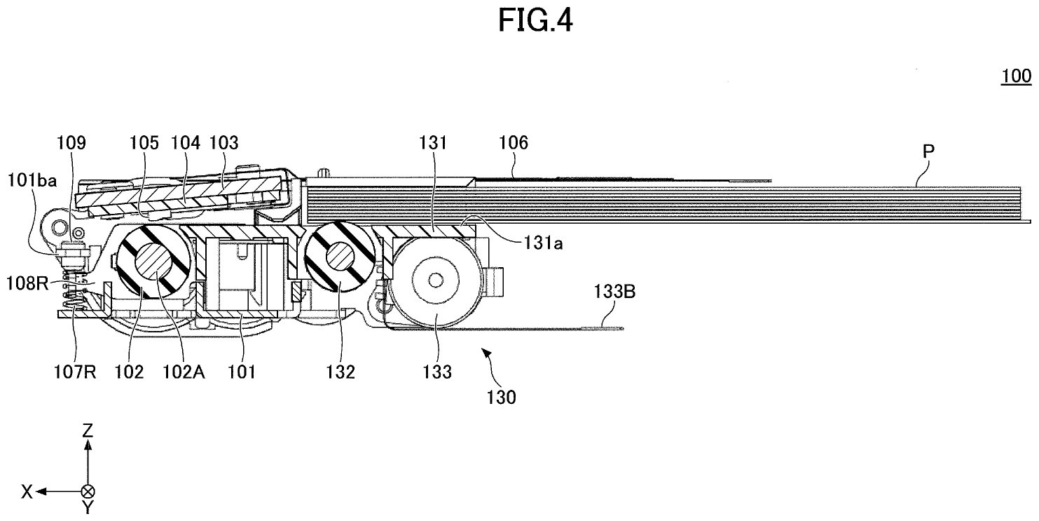

FIG. 1 is a perspective view illustrating an appearance of the thermal printer 100 according to the embodiment. FIG. 2 is a right side view of the thermal printer 100 according to the embodiment. FIG. 3 is a front view of the thermal printer 100 according to the embodiment. FIG. 4 is a cross-sectional view of the thermal printer 100 illustrated in FIG. 1 taken along the line A-A.

In the following description, for convenience, the X-axis direction in the drawing (a conveying direction of a thermal paper P) is a front and rear direction, the Y-axis direction in the drawing (a direction orthogonal to the conveying direction of the thermal paper P) is a right and left direction, and the Z-axis direction in the drawing (a direction orthogonal to the X-axis and the Y-axis) is an up and down direction. Here, a positive X-axis direction is front, a positive Y-axis direction is right, and a positive Z-axis direction is up.

The thermal printer 100 illustrated in FIGS. 1 to 4 is an example of “an image forming apparatus” and is what is called a thermal printer that can form an image on the thermal paper P with heating the thermal paper P with heating elements provided in a thermal head 105 while the the thermal paper P is pressed against the thermal head 105.

As illustrated in FIGS. 1 to 4, the thermal printer 100 includes a frame 101, a platen roller 102, a support member 103, a plate 104, a thermal head 105, Flexible Printed Circuits (FPC) 106, a coil spring 107L, a coil spring 107R, a lever 108L, a lever 108R, and a conveying unit 130.

The frame 101 is a tray-shaped member formed by machining a metal plate. The frame 101 includes a left wall 101a, a right wall 101b, and a bottom plate 101c. The left wall 101a is a part vertically provided at a left end (a negative end of the Y-axis in the drawing) of the frame 101. The right wall 101b is a part vertically provided at a right end (a positive end of the Y-axis in the drawing) of the frame 101. The bottom plate 101c extends laterally (in the Y-axis direction in the drawing) at a lower end of the frame 101, and connects the left wall 101a to the right wall 101b.

The platen roller 102 is a cylindrical member that extends laterally (i.e., in the Y-axis direction in the drawing) between the left wall 101a and the right wall 101b of the frame 101. The platen roller 102 is rotatably supported at both ends of a rotating shaft 102A of the platen roller 102 by bearings 101A attached to the left wall 101a and the right wall 101b of the frame 101. The platen roller 102 is provided under the thermal head 105 to face the thermal head 105. The platen roller 102 presses a surface of the thermal paper P against the thermal head 105 by inserting the thermal paper. P into a gap between the platen roller 102 and the thermal head 105. The platen roller 102 is rotated by a motor 133 drive, so that the platen roller 102 can convey the thermal paper P in a predetermined conveying direction (i.e., the positive X-axis direction in the drawing). An elastic material such as rubber, for example, may be used for a roller part of the platen roller 102. A relatively hard material such as metal, for example, may be used for the rotating shaft 102A of the platen roller 102.

The support member 103 is a cover member with an approximately horizontal flat surface, which is formed by machining a metal plate (e.g., a galvanized steel plate). The support member 103 is attached to an upper part of the frame 101 such that a part of an inner space of the frame 101 (i.e., a space in which the plate 104 and the thermal head 105 are housed) is closed from above. The plate 104 is screwed to a lower surface of the support member 103 by fixing screws 103B passing through the support member 103 from above. Thus, the support member 103 supports the thermal head 105 via the plate 104. The support member 103 is screwed to an upper part of the frame 101 by the fixing screws 1035 passing through the support member 103 from above at both left and right ends of a front side (a positive side of the X-axis in the drawing) of the support member 103. The support member 103 also has adjustment screws 103A passing through the support member 103 from above at both left and right ends of a back side (a negative side of the X-axis in the drawing) of the support member 103. The tips of the adjustment screws 103A contact the upper surfaces of the left wall 101a and the right wall 101b of the frame 101. The adjustment screw 103A adjusts the height and the tilt angle of the support member 103 by adjusting protrusion amount from the lower surface of support member 103. As the thermal head 105 is held by the support member 103, the thermal printer 100 according to the present embodiment can adjust the gap between the thermal head 105 and the platen roller 102, and the tilt angle of the thermal head 105, through adjustment of the height and the tilt angle of the support member 103.

The plate 104 is an example of a “holding plate” that holds the thermal head 105 from above. The plate 104 is attached to a lower surface of the support member 103. The plate 104 is a flat plate-shaped member having an approximately horizontal flat surface. A relatively hard material, such as metal, may be used for the plate 104, for example.

The thermal head 105 is held by a lower surface of the plate 104 and is provided to face the platen roller 102. The thermal head 105 provides multiple heating elements to be side by side in a width direction (i.e., the Y-axis direction in the drawing and the direction orthogonal to the conveying direction of the thermal paper P). A slight gap, which is smaller than the thickness of the thermal paper P, is formed between the thermal head 105 and the platen roller 102. For example, when the thickness of the thermal paper P is 0.25 mm, a gap of 0.15 mm may be formed between the thermal head 105 and the platen roller 102. This enables the surface of the thermal paper P to be pressed against the thermal head 105 at an appropriate pressure when the thermal paper P is inserted between the thermal head 105 and the platen roller 102. Heat generation of the multiple heating elements is controlled by a control signal supplied from an external circuit through the FPC 106 while the surface of the thermal paper P is pressed against the thermal head 105, so that the thermal head 105 can form an image on the thermal paper P.

The FPC 106 is a member that connects the thermal head 105 to the external circuit (which is not illustrated) to supply a control signal to the thermal head 105. The FPC 106 is a wiring film member having a laminated structure in which wires formed of metal films are sandwiched by resin films such as polyimides. The FPC 106 is flexible and can be bent.

A pair of coil springs 107L and 107R is an example of “a pair of urging means”. The coil spring 107R is sandwiched between a front end (a positive end of the X-axis) of the lever 1088 supporting a right end (an example of “one end”) of the rotating shaft 102A of the platen roller 102 and the bottom plate 101c of the frame 101, and can be elastically deformed in the up and down direction. The coil spring 107L is sandwiched between a front end (a positive end of the X-axis) of the lever 108L supporting a left end (an example of “the other end”) of the rotating shaft 102A of the platen roller 102 and the bottom plate 101c of the frame 101, and can be elastically deformed in the up and down direction. The coil springs 107L and 107R urge the levers 108L and 108R upward, so that the coil springs 107L and 107R urge the platen rollers 102 supported at both ends by the levers 108L and 108R upward. This causes the coil springs 107L and 107R to generate upward press force against the platen roller 102 to press the thermal paper P between the thermal head 105 and the platen roller 102.

Horizontal screw fixing parts 101aa and 101ba are provided at front ends of the left wall 101a and the right wall 101b of the frame 101. The screw fixing parts 101aa and 101ba are provided with adjustment screws 109 passing through the screw fixing parts 101aa and 101ba from above. The tips of the adjustment screws 109 contact the upper surfaces of front ends of the levers 108L and 108R. The adjustment screws 109 adjust the rotation angles of the levers 108L and 108R by adjusting protrusion amount from the lower surfaces of the screw fixing parts 101aa and 101ba. As both ends of the platen roller 102 are supported by levers 108L and 108R, the thermal printer 100 according to the present embodiment can adjust the height of the platen roller 102 (i.e., the maximum height when the thermal paper P is not sandwiched) by adjusting the rotation angles of the levers 108L and 108R.

The conveying unit 130 is removable from the frame 101 and is incorporated into a rear of the frame 101. The conveying unit 130 includes a conveying guide 131, a paper feed roller 132, and a motor 133.

The conveying guide 131 is a resin member attached to the frame 101 with components being incorporated (i.e., the paper feed roller 132, the motor 133, etc.). The conveying guide 131 includes a horizontal conveying surface 131a, a left wall 131b vertically provided at a left end of the conveying surface 131a, and a right wall 131c vertically provided at a right end of the conveying surface 131a. The conveying guide 131 guides the conveyance of the thermal paper P to a printing position by placing the thermal paper P (an example of “the printing medium”) on the conveying surface 131a, specifying the height of the thermal paper P with the conveying surface 131a, and specifying left and right positions of the thermal paper P with the left wall 131b and the right wall 131c so that a conveyance position of the thermal paper P becomes appropriate.

The paper feed roller 132 conveys the thermal paper P placed on the conveying guide 131 into the gap between the platen roller 102 and the thermal head 105 by being rotated in accordance with the rotation of the platen roller 102 through gears 110F, 110G, and 110H (i.e., an example of “a plurality of gears”) disposed on a left side of the thermal printer 100.

The motor 133 rotates a rotating shaft 133A of the motor 133 in accordance with a control signal supplied from an external circuit (which is not illustrated) through FPC 13313. This causes the motor 133 to rotate the platen roller 102 through gears 1101\, 1103, 1100, 110D, and 110E disposed on a right side of the thermal printer 100 in accordance with printing timing for the thermal paper P. The motor 133 may be, for example, a stepper motor. The gears 110D and 110E are covered by a gear cover 112. In FIG. 2, the gear cover 112 is not illustrated.

In the thermal printer 100 configured as described above, the thermal paper P placed on the conveying surface 131a of the conveying guide 131 is conveyed into the gap between the thermal head 105 and the platen roller 102 by the rotation of the paper feed roller 132. Then, the thermal head 105 and the platen roller 102 sandwich the conveyed thermal paper P. In this state, while the platen roller 102 is rotated by the motor 133 drive, a control signal corresponding to print data is input from an external circuit (which is not illustrated) to the thermal head 105 through the FPC 106. The thermal head 105 heats the thermal paper P with multiple heating elements heating in accordance with an input control signal. This causes the thermal head 105 to form an image corresponding to the printed data on the thermal paper P.

(Operation of the Thermal Printer 100)

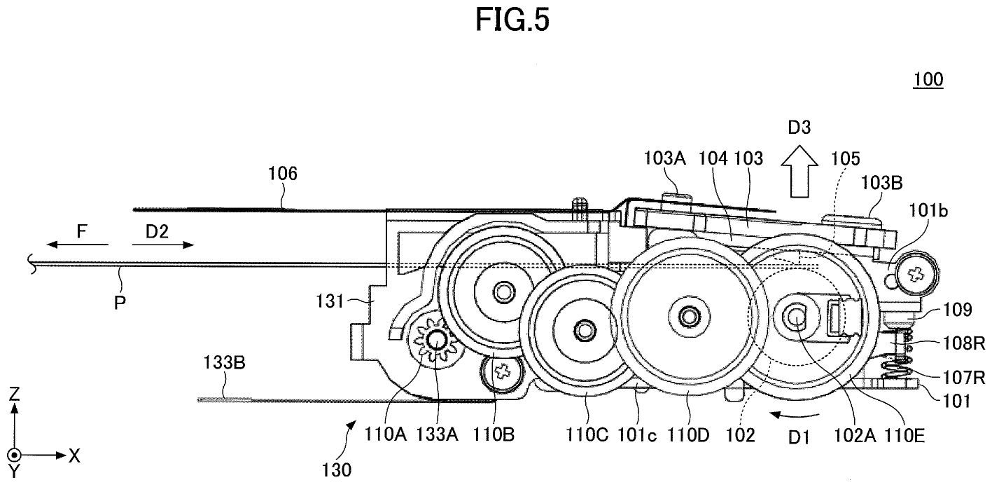

FIG. 5 is a drawing for describing an operation of the thermal printer 100 according to the embodiment. As illustrated in FIG. 5, the thermal printer 100 according to the present embodiment employs a configuration in which driving force generated by the motor 133 is transmitted to the platen roller 102 through the gears 110A, 110B, 110C, 110D, and 110E disposed on the right side of the frame 101 so as to rotate the platen roller 102. The final stage gear 110E is fixed to the right end of the rotating shaft 102A of the platen roller 102. This causes the platen roller 102 to be rotated by the rotation of the gear 110E.

As illustrated in FIG. 5, in the thermal printer 100 of the present embodiment, the gear 110E and the platen roller 102 are driven by the motor 133 to rotate clockwise (i.e., in a direction of the arrow D1 in the drawing) when viewed from the right side (i.e., a positive side of the Y-axis). As a result, the thermal paper P is conveyed to the front (in a positive direction of the X-axis and a direction of the arrow D2 in the drawing) between the platen roller 102 and the thermal head 105 by the platen roller 102.

Here, friction is generated between the thermal paper P, and the thermal head 105, the conveying guide 131, a separator, or the like when the thermal paper P is conveyed to the front (i.e., in the positive direction of the X-axis). This friction causes a load F toward a rear side (in a negative direction of the X-axis) in the thermal paper P, and the load F effects the final stage gear 110E through the platen roller 102, so that force to be pulled upward is generated at the gear 110E. This pulls the right end of the platen roller 102 upward with the gear 110E (in a direction of the arrow D3 in the drawing).

As a result, the press force against the thermal paper P in a driving side portion (i.e., a right side portion) of the platen roller 102 is stronger than the press force against the thermal paper P in a non-driving side (i.e., a left side) of the platen roller 102. That is, the press force exerted by the platen roller 102 differs along the Y-axis of the platen roller 102. The difference in press force between the left and right sides of the platen roller 102 might cause a difference in printing density of the thermal paper P.

In the thermal printer 100 according to the present embodiment, the spring force applied by the coil spring 107R at the driving side is lower than the spring force applied by the coil spring 107L at the non-driving side so that the press force of the platen roller 102 is uniform in the left and right direction. Specifically, the coil spring 10/R has a spring force smaller than the spring force of the coil spring 107L.

In the thermal printer 100 according to the present embodiment, a press force P1 is generated on the thermal paper P based on the spring force of the coil spring 107R and an upward force generated at the gear 110E on the driving side of the platen roller 102 at printing. On the non-driving side of the platen roller 102, a press force P2 is generated based on the spring force of the coil spring 107L. At this time, the press force P1 and the press force P2 are configured to be equal.

Therefore, according to the thermal printer 100 of the present embodiment, it is possible to suppress a difference between right printing density and left printing density that might occur because of a difference between a right press force and a left press force generated by the platen roller 102 at printing.

The thermal printer 100 according to the present embodiment uses the coil springs 107L and 107R having different spring forces. Therefore, when the platen roller 102 is not rotated, the thermal printer 100 has a difference between the press force at the driving side of the platen roller 102 and the press force at the non-driving side of the platen roller 102 based on a difference in urging force of the pair of coil springs 107L and 107R. When the platen roller 102 is rotated, the difference in the press force based on the difference in the urging force of the pair of the coil spring 107L and the coil spring 107R is reduced. In particular, the thermal printer 100 according to the present embodiment removes the difference in the press force based on the difference in the urging force of the pair of coil springs 107L and 107R when the platen roller 102 is rotated.

### Example

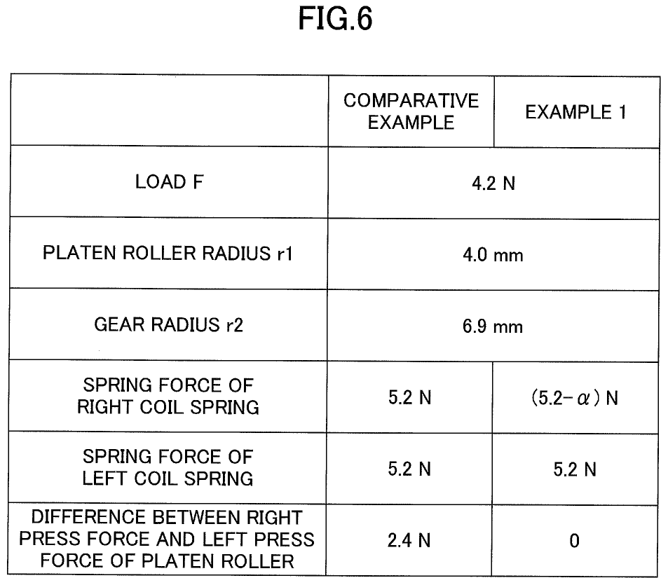

FIG. 6 is a drawing illustrating one example of the thermal printer 100 according to the embodiment. FIG. 6 indicates executing conditions and an executing result for each of a thermal printer of a comparative example and a thermal printer of Example 1. In the thermal printer of the comparative example, the spring force of the coil spring 107L and the spring force of the coil spring 107R are equal to each other in the thermal printer 100 described in the embodiment. In the thermal printer of Example 1, the spring force of the coil spring 107L is smaller than the spring force of the coil spring 107R in the thermal printer 100 described in the embodiment.

As illustrated in FIG. 6, the spring force of the coil spring 107L and the spring force of the coil spring 107R in the thermal printer of the comparative example are “5.2 N”. Therefore, in the thermal printer of the comparative example, when the load F on the thermal paper P is “4.2 N”, it was observed that the press force of the right side of the platen roller 102 is greater than the press force of the left side of the platen roller 102 by “2.4 N”.

With respect to the above, as illustrated in FIG. 6, in the thermal printer of Example 1, the spring force of the coil spring 107R is “(5.2−α) N”, and the spring force of the coil spring 107L is “5.2 N”. That is, in the thermal printer of Example 1, in consideration of “2.4 N” that is the difference between the right press force and the left press force caused by the platen roller 102 in the thermal printer of the comparative example, the spring force of the coil spring 107R on the driving side is configured to be smaller than the spring force of the coil spring 107L on the non-driving side by “αN”. By this, in the thermal printer of Example 1, it was observed that the press force of the right side of the platen roller 102 and the press force of the left side of the platen roller 102 are equal to each other when the load F on the thermal paper P is “4.2 N”. A suitable value of a may be obtained by a simulation or a mathematical formula, for example, or a suitable value may be obtained by a test of an actual machine, for example.

An example embodiment of the invention has been described in detail above, but the invention is not limited to the described embodiment. Various modifications or alterations can be made within the scope of the invention as recited in the claims.

For example, in the embodiment, a configuration in which the pair of coil springs 1071 and 107R having different spring forces is configured to urge the platen roller 102 toward the thermal head 105, is employed, but the embodiment is not limited to this. For example, a configuration in which the pair of coil springs 107L and 107R having different spring forces for urging the thermal head 105 toward the platen roller 102, may be employed.

In the embodiment, the pair of coil springs 1071 and 107R is used as an example of “a pair of urging means”, but “a pair of urging means” is not limited to this. As “a pair of urging means”, another urging means (e.g., a flat spring, rubber, etc.) may be used.

Additionally, in the described embodiment, a pair of coil springs 1071 and 107R having different spring forces is used so that the urging forces on the platen roller 102 differ at the left side and right side of the platen roller 102. However, the invention is not limited to this. For example, a pair of coil springs having equal spring forces may be used with an appropriate means for adjusting the spring force of one or both of the pair of coil springs (e.g., an adjusting screw, a spacer, etc.) so that the urging forces on the platen roller 102 differ at the left side and the right side of the platen roller 102.

What is claimed is:

1. An image forming apparatus comprising:
a frame;
a platen roller having a first end and a second end, each of the first and second ends being rotatably supported by the frame;
a thermal head that faces the platen roller and that forms an image on a printing medium interposed between the platen roller and the thermal head, the thermal head having a first end and a second end;
a gear that is provided on the first end of the platen roller and that is rotated by receiving a driving force from a motor, the rotation of the gear causing the platen roller to rotate; and
a pair of urging means configured to urge the first end and the second end of the platen roller or the thermal head,
wherein an urging force generated by one of the pair of urging means provided on the first end is smaller than an urging force generated by the other of the pair of urging means provided on the second end.

2. The image forming apparatus as claimed in claim 1, wherein the urging force generated by the one of the pair of urging means provided on the first end is configured to be smaller than the urging force generated by the other of the pair of urging means provided on the second end by an amount based on a difference between a press force exerted on the printing medium at the first end and a press force exerted on the printing medium at the second end, wherein the difference between the press forces at the first end and the second end is caused by a load on the gear when the platen roller is rotated.

3. The image forming apparatus as claimed in claim 2, wherein a difference in a press force between the first end and the second end of the platen roller exists based on a difference in the urging force between the pair of urging means when the platen roller is not rotated, and the difference in the press force based on the difference in the urging force between the pair of urging means becomes small when the platen roller is rotated.

4. The image forming apparatus as claimed in claim 3, wherein the difference in the press force based on the difference in the urging force between the pair of urging means when the platen roller is not rotated is substantially equal to the difference between the press forces at the first end and the second end that is caused by the load on the gear when the platen roller is rotated.

5. The image forming apparatus as claimed in claim 1, wherein the pair of urging means is a pair of coil springs having different spring forces.
